(19) United States
(12) Patent Application Publication
(10) Pub. No.: US 2007/0212075 A1
(43) Pub. Date: Sep. 13, 2007

(54) DUAL-PARALLEL-MZ MODULATOR BIAS CONTROL

(75) Inventor: Yan Yin, Fremont, CA (US)

Correspondence Address: MOLLBORN PATENTS, 2840 COLBY DRIVE, BOULDER, CO, 80305, US

(73) Assignee: YY Labs, Inc., Fremont, CA (US)

(21) Appl. No.: 11/683,419

(22) Filed: Mar. 7, 2007

Related U.S. Application Data
(60) Provisional application No. 60/781,148, filed on Mar. 9, 2006.

(51) Int. Cl. H04B 10/04

(52) U.S. Cl. 398/183

(57) ABSTRACT

Methods and apparatus, including computer program products, implementing and using techniques for controlling three or more nested modulators in an optical signal application. A single bias controller circuit is coupled to the respective DC biases for each of the nested modulators. The bias controller circuit sends a separate bias control signal to each of the nested modulators to set a working point for each of the nested modulators. An optical filter located at the output of the nested modulators in the path of a tapped signal and coupled to the bias controller circuit passes a carrier wavelength of the optical signal and blocks wavelengths other than the carrier wavelength. At least one photo detector is coupled to the bias controller circuit and senses an error signal associated with a pilot tone.

### CROSS-REFERENCE TO RELATED APPLICATIONS

The present application claims priority under 35 U.S.C. 119(e) from U.S. Provisional Patent Application No. 60/781,148 entitled “A METHOD AND DEVICE FOR DUAL-PARALLEL-MZ MODULATOR BIAS CONTROL” filed Mar. 9, 2006, the entire disclosure of which is incorporated herein by reference for all purposes.

### BACKGROUND

This invention relates to the communication field. In particular, the invention relates to improving optical transmission properties in communications applications.

A Dual-Parallel-MZ (DPMZ) modulator is a device that has recently been gaining popularity in the communications field for increasing the distance of transmission of an optical signal and for increasing the bit rates, both of which are in high demand. The Dual-Parallel-MZ modulator is a combination of three nested Mach-Zehnder (MZ) modulators. As is well-known to those of ordinary skill in the art, the working function for the MZ modulator drifts when the temperature and other working conditions change. A bias-control circuit is therefore necessary in order to lock the working point to the drifting working function of the MZ modulator. The DPMZ modulator has three bias points requiring control.

FIG. 1 shows an example of a modulator working function (100), also referred to as a transfer function. The working function (100) is a sin wave, which represents the relationship between the bias voltage (V_{bias}) and the intensity (I) of an output optical signal. The minimum point of the working function is called Null, and the maximum point is called Peak. The linear point is called Quad. As can be seen in FIG. 1, there is one Quad point on each slope of the working function. Quad+ is on the positive slope and Quad− is on the negative slope. Vπ (represents the required voltage of the driving signal amplitude which is applied on the bias in order to drive the modulator from the Null point to the Peak point.

DQPSK (Differential Quadrature Phase-Shift Key) modulation is a technique used to improve optical transmission properties such as total reach, dispersion tolerance, or spectral efficiency. However, DQPSK must use three nested modulators, with two modulators working at the minimum working point (Null), and one modulator working at the linear working point (Quad). In particular, the DQPSK modulation requires that the amplitude of the RF driving signal is close to twice the Vπ Voltage.

Singleside-band (SSB) modulation is a special working method for obtaining single-side-band operation to obtain higher-density wavelength multiplexing and longer haul-fiber optical transmission due to reduced optical power and fewer nonlinear optical effects. To implement SSB modulation, a DPMZ modulator is required, with the first two modulators working at the Null point, and the third modulator working at Quad point. The difference between the DQPSK and the SSB modes from the RF signal's point of view is that the DQPSK mode requires the RF driving signal to have an amplitude of 2Vπ, whereas the SSB mode requires the RF driving signal to have an amplitude of Vπ.

The amplitude of the RF driving signal is important in the design of the modulator bias controller. Furthermore, having three nested modulators and only one photo diode available to give a sum signal for the three modulators also increases the complexity for controlling each of the three modulators at their respective desired working points.

A conventional bias controller can only work with one or two modulators. In particular, a conventional bias controller cannot work with RF driving signals as large as close to 2Vπ, which is required in a DQPSK operation mode using a DPMZ modulator. Thus, there is a need for an improved bias controller that can control the bias positions for a DPMZ modulator in DQPSK or SSB applications.

### SUMMARY

The present invention provides methods and apparatus for controlling DPMZ modulators for RF driving signals with amplitudes close to 2Vπ in a DQPSK application, and with amplitudes close to Vπ in a SSB application, respectively.

In general, in one aspect, the invention provides methods and apparatus, including computer program products, implementing and using techniques for controlling three or more nested modulators in an optical signal application. One bias controller circuit is coupled to the respective DC biases for each nested modulator. The bias controller circuit sends a separate bias control signal to each of the nested modulators to set a working point for each of the nested modulators. An optical filter located at the output of the nested modulators in the path of a tapped signal and coupled to the bias controller circuit passes a carrier wavelength of the optical signal and blocks wavelengths other than the carrier wavelength. At least one photo detector is coupled to the bias controller circuit and senses an error signal associated with a pilot tone.

Advantageous implementations can include one or more of the following features. The modulators can be Mach-Zehnder modulators forming a Dual Parallel Mach-Zehnder modulator and the optical signal transmission application can be a Differential Quadrature Phase-Shift Key modulation application or other applications require the same setting of the nested modulators. Two photo detectors can be coupled to the bias controller circuit, where each of the two photo detectors senses an error signal associated with the pilot tone from the first two modulators and the third modulator respectively.

The modulators can be Mach-Zehnder modulators forming a Dual Parallel Mach-Zehnder modulator and the optical signal transmission application can be a Single Side Band modulation application. A single photo detector can be coupled to the bias controller circuit to sense an error signal associated with the pilot tone from the three modulators.

The optical filter can be a narrow-band optical filter, an interferometer based filter, a comb filter, or a narrow band filter operable to work for one particular wavelength. One of the photo detectors can be a built-in photodiode in the DPMZ modulator. The bias controller circuit can use a time-division method to separately control each of the nested modulators. A pilot signal can be sent in sequence to the first modulator, the second modulator, and the third modulator, respectively, and the time intervals between sending of the pilot signal for locking each individual modulator can be chosen so that no significant drift will occur for each modulator in the time intervals between receiving pilot signals. The bias controller circuit further is operable to apply an extra error signal to obtain a user selectable working point for each modulator.

The various embodiments of the invention can be implemented to include one or more of the following advantages. One device can control three nested MZ modulators. The device uses a timing division method. As a result, there is no problem of pilot signal interference, which otherwise could occur if three separate controllers were used. The device controls each modulator at the proper working point, even when the amplitude of the RF driving signal is close to 2Vπ in a DQPSK mode. The device controls each modulator at the proper working point, even when the amplitude of the RF driving signal is close to Vπ in a SSB mode. The device has tuning capability for applications that require a working point away from the Null, Peak or Quad points, respectively.

The details of one or more embodiments of the invention are set forth in the accompanying drawings and the description below. Other features and advantages of the invention will be apparent from the description and drawings, and from the claims.

### DESCRIPTION OF DRAWINGS

FIG. 1 shows an exemplary MZ modulator working function.

FIG. 2 is a schematic diagram showing a conventional configuration of an MZ modulator and its bias controller for analog or digital applications

FIG. 3 is a schematic diagram showing a Dual-Parallel-Mach-Zehnder (DPMZ) modulator in accordance with one embodiment of the invention.

FIG. 4 is a diagram showing the effectiveness of locking the Null point in relation to the RF driving signal amplitude in the prior art and in accordance with one embodiment of the invention, respectively.

FIG. 5 is a schematic diagram showing a system in accordance with one embodiment of the invention.

FIG. 6 is a schematic diagram showing a timing division method for controlling three nested modulators in accordance with one embodiment of the invention.

FIG. 7 is schematic diagram showing system configuration for a DQPSK operation mode in accordance with one embodiment of the invention.

FIG. 8 is a schematic diagram showing a system configuration for an SSB operation mode in accordance with one embodiment of the invention.

FIGS. 9-12 show a series of measurements of a spectrum without and with a Band Pass filter in accordance with one embodiment of the invention.

FIG. 13 is a schematic diagram of a system in accordance with one embodiment of the invention showing the principle of locking to an arbitrary point of the working function.

Like reference symbols in the various drawings indicate like elements.

### DETAILED DESCRIPTION

The invention will be described below by way of example and with reference to a Dual-Parallel-MZ modulator bias controller (DPMZ MBC), which is configured to simultaneously set the first and second modulators to the Null points and the third modulator to the Quad point. In some embodiments, the points to be locked can be tuned away from the Null and the Quad points in order to meet special requirements of desired working points for particular applications. As will be discussed in further detail below, the bias controller can control three nested modulators with only one bias control circuit and one pilot tone, and the RF driving signal amplitude can be as large as close to 2Vπ for DQPSK applications, where Vπ represents the required bias voltage for the MZ modulator to change its output intensity from minimum to maximum. The circuit can also work for Single-Side-Band applications, where the RF driving signal is as large as close to Vπ.

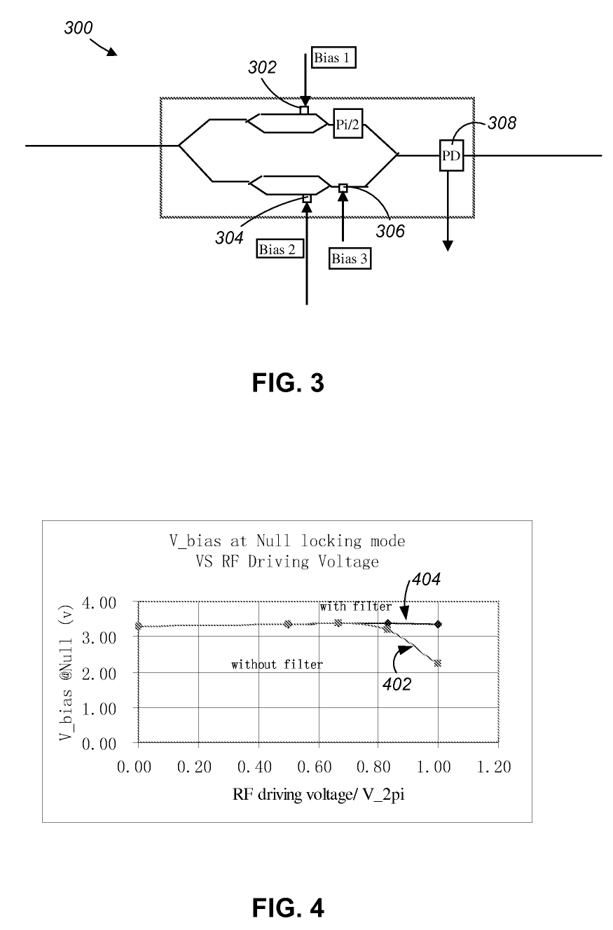

FIG. 3 shows a DPMZ modulator (300), which includes three MZ modulators (302; 304; 306). Two of the MZ modulators (302; 304) are connected in parallel, effectively forming another MZ modulator. The first MZ modulator (302) and the second MZ modulator (304) work at the Null position, whereas the third MZ modulator (306) works at the Quad position. Some DPMZ modulators (300) have a built-in photo detector (308), although this is not a requirement. Some DPMZ modulators have separate bias control electrodes, whereas others have RF electrodes only. The various embodiments of the bias controller, which will be described below, works for all of these cases.

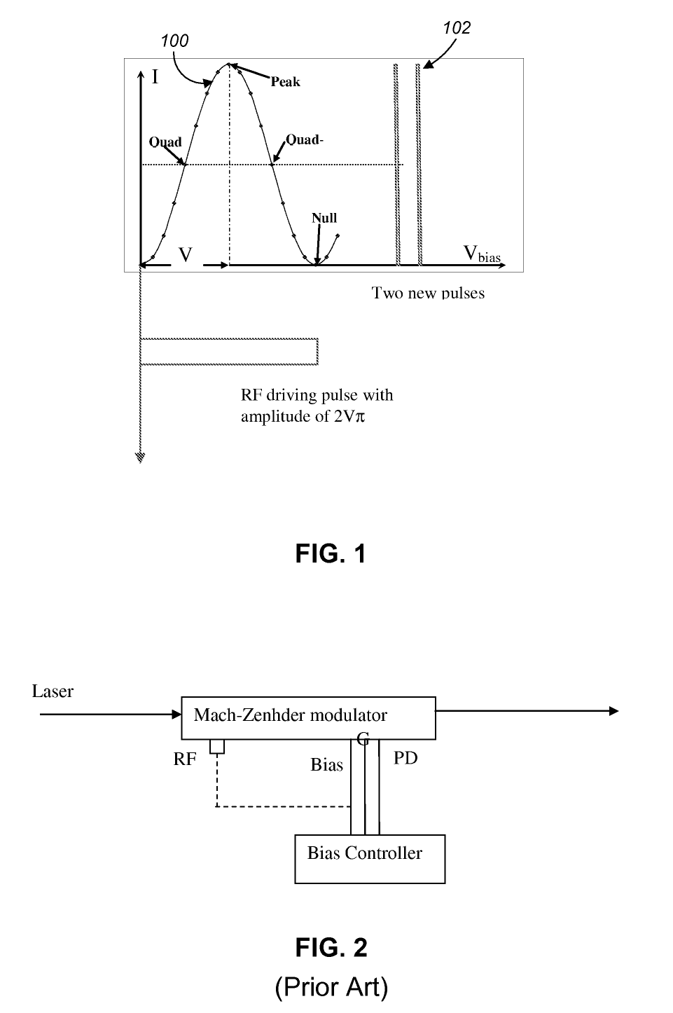

In order for a modulator to work at the Null point, the conventional approach involves applying a pilot tone to the bias electrode, detecting an error signal, and trying to minimize the detected error signal. A filter and a synchronous detector in the circuit are typically used to eliminate interference from an RF driving signal or from sidebands generated by the RF driving signal. This technique works well until the RF driving signal gets close to 2Vπ. Referring back to FIG. 1, when the amplitude of the RF driving signal is close to 2Vπ, each rising edge and falling edge of the RF driving pulse will generate another two very short pulses (102) with very sharp rising and falling edges. The amplitude of the carrier wavelength and side bands are no longer the same as the case with lower RF voltage driving. As a result, the bias controller may not sense enough carrier signals. From a spectrum point of view, when locking to Null, the wavelength of the carrier should be suppressed, whereas the side bands should be retained for use in applications. From the bias point of view, the bias voltage corresponding to the Null position should stay the same irrespective of whether the RF driving signal is applied or not. FIG. 4 shows that in the conventional approach, illustrated by the lower “without filter” curve (402), the locking point shifts away when the amplitude of the RF driving signal is larger than approximately 80% of the 2Vπ amplitude, since the bias voltage is shifting away from the Null point.

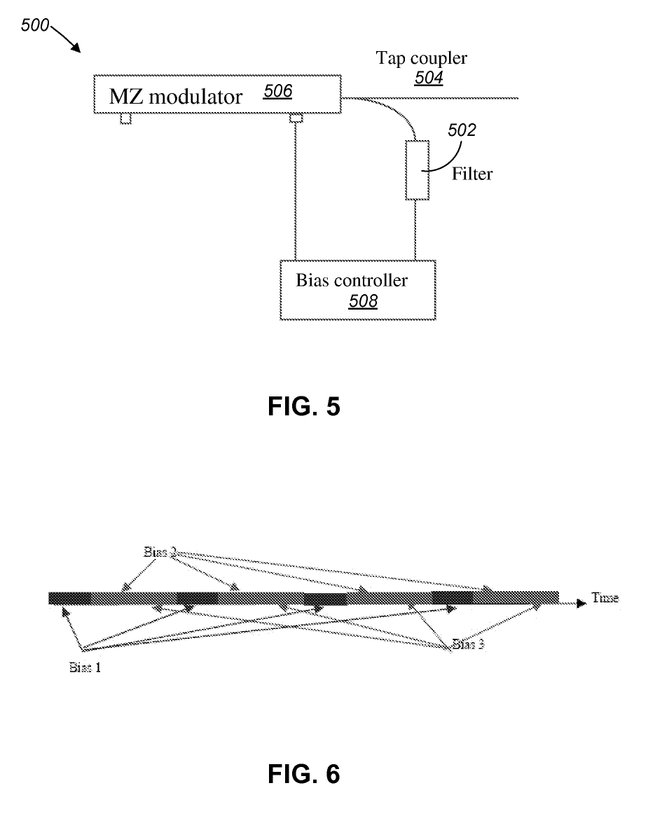

These undesired effects can be avoided in accordance with various embodiments of the invention, by a configuration (500) as shown in FIGS. 5-8. As can be seen in FIG. 5, a narrow band filter (502) is placed in the path of the tap end of a tap coupler (504), which is located at the output of the MZ modulator (506). The bandwidth in the illustrated embodiment is ±1.5 GHz. The narrow band filter (502) only allows the carrier wavelength to pass and blocks all the other wavelengths generated by the side bands with frequency higher than 3 GHz. As a result, the Bias Controller (508) only senses the carrier wavelength. Once the carrier wavelength has been sensed, the bias controller circuit (508) provides feedback to the MZ modulator (506) to control the bias to a point where the carrier wavelength remains suppressed, thereby locking the MZ modulator (506) to the Null position. As can be seen in the “with filter” curve (404) of FIG. 4, the locking point is maintained, even when the amplitude of the RF driving signal is close to the 2Vπ amplitude. Thus very good results can be achieved with this configuration for DQPSK applications.

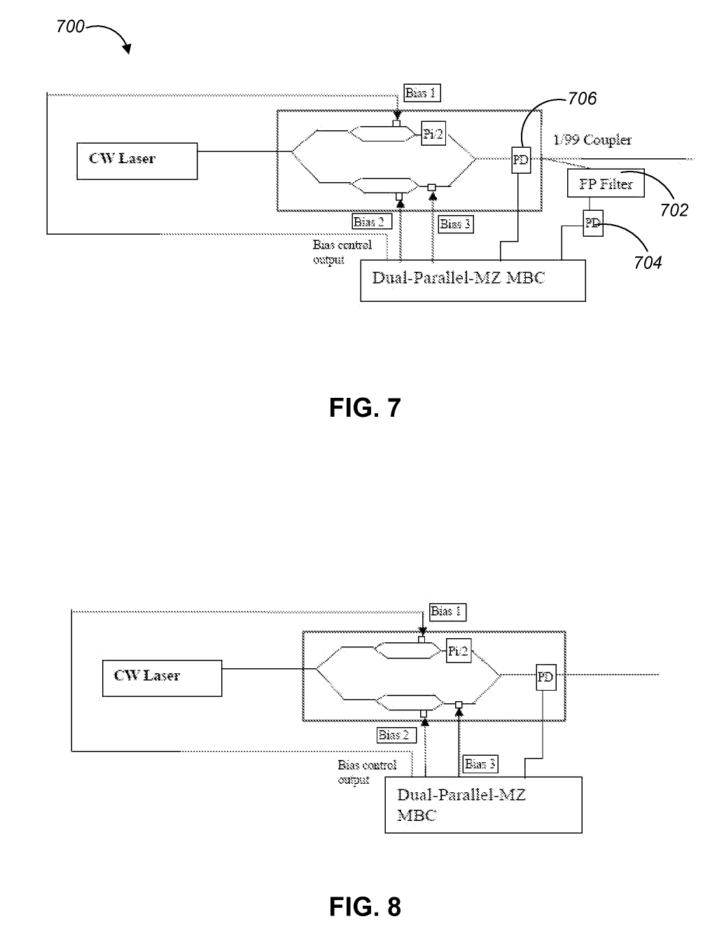

In some embodiments, the narrow band filter (502) can be a Fabry-Perot (FP) filter, for example, with a bandwidth of 1.5 GHz. FIG. 7 shows such a system configuration (700) in accordance with one embodiment of the invention. Since the FP filter (702) is a comb filter, the filter allows any wavelength used on the International Telecommunication Union (ITU) grid to pass. Thus, a single filter can be used for the DPMZ modulator for the entire telecom wavelength range. As can be seen in FIG. 7, there are two photo detectors (704; 706) in the system (700). Both photo detectors can be external photo detectors, or one of the photo detectors can be a built-in photo detector (706) of the DPMZ modulator, as shown in FIG. 7. If two photo detectors are used, two optical splitters with a ratio of 1%-5% or any ratio suitable for the system are used to split off a partial signal to the feedback loop of the bias controller circuit. If only one external photo detector (704) is used, then only one optical splitter is needed.

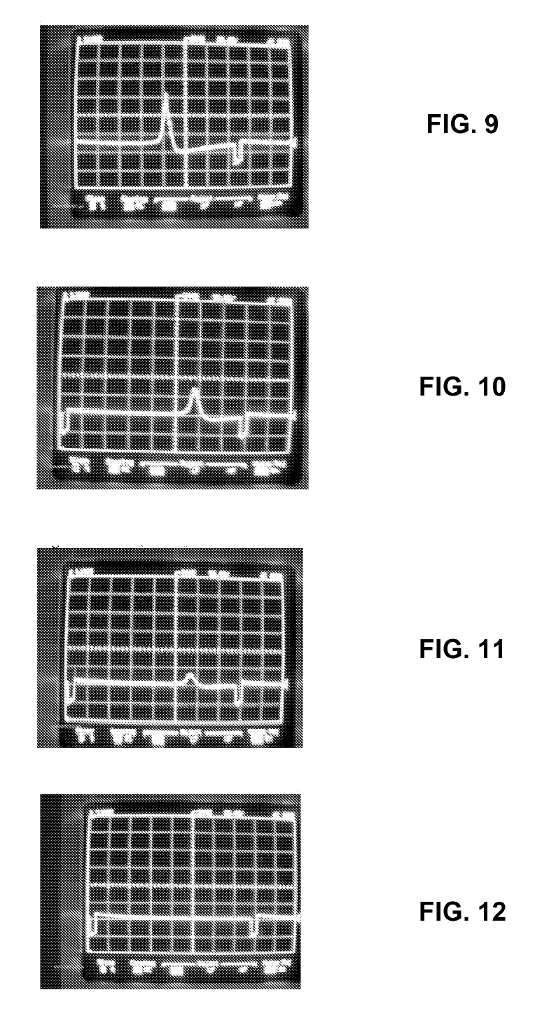

FIGS. 9-12 show measurements of the spectrum without and with FP filter, respectively, as measured with a Coherent 251 Spectrum Analyzer, manufactured by Coherent Inc. of Santa Clara, Calif. FIGS. 9 and 10 show the carrier frequency when the bias controller is not being used. In particular, FIG. 9 shows a situation when an RF driving signal is not applied and FIG. 10 shows a situation when an RF driving signal is applied. FIGS. 11 and 12 show a situation when both an RF driving signal and a bias controller are applied. In particular, FIG. 11 shows that the carrier frequency cannot be suppressed with prior art techniques, that is, without a filter. FIG. 12, on the other hand, shows that the carrier frequency is suppressed using the techniques in accordance with various embodiments of the invention. Since this spectrum analyzer is a very narrow band spectrum analyzer, the side bands are not visible in the same screen.

As the skilled reader realizes, for SSB applications, the RF driving voltage is only up to Vπ, therefore, there is no need to use the filter, and a simpler configuration as shown in FIG. 8 can be used. However, there are other problems associated with using conventional modulator bias controllers. In DQPSK and SSB applications, or in any applications involving nested MZ modulators, the bias control becomes challenging. One of the reasons is that when there are three pilot tones involved, these pilot tones may interfere each other. The disturbance to the system is also larger and has become a major concern.

In order to overcome this deficiency, various embodiments of the invention use a time-division method to control the three MZ modulators in a time sequence. The drifting is a slow process. As will be seen below, in accordance with various embodiments of the invention, the time during which the drifting is not controlled for each modulator is typically in the order of approximately a 100 ms interval. During this time interval, the drifting is fairly insignificant and it is easy for the bias control to re-lock the gain to the proper position once the bias control is reapplied to the modulator.

The time-division method works as follows. First, the bias controller applies a pilot tone to the first modulator to lock the first modulator to Null. Next, the bias controller applies a pilot tone to the second modulator to lock the second modulator to Null, while the bias voltage of the first modulator retains its previous value. The bias controller then applies a pilot tone to the third modulator to lock the third modulator to Quad, as required, while the first and second modulator have no pilot tone applied and retain their bias voltage unchanged. Next, the bias controller reapplies a pilot tone to the first modulator to lock the first modulator to Null, and so on. The interval between each locking process is only about 250 ms (it can be longer or shorter as desired). Thus, even though the working function is drifting, it is not a problem for the bias controller to lock the working point to the proper position from the previous bias voltage value of the modulators.

An exemplary time sequence of the overall controlling process for MZ modulators 1, 2 and 3 is shown in FIG. 6. The different colors represent three controlling processes for MZ modulators 1, 2 and 3. As the skilled person realizes, this method can be used not only in DQPSK or SSB applications, but also in other applications involving a nested MZ modulator.

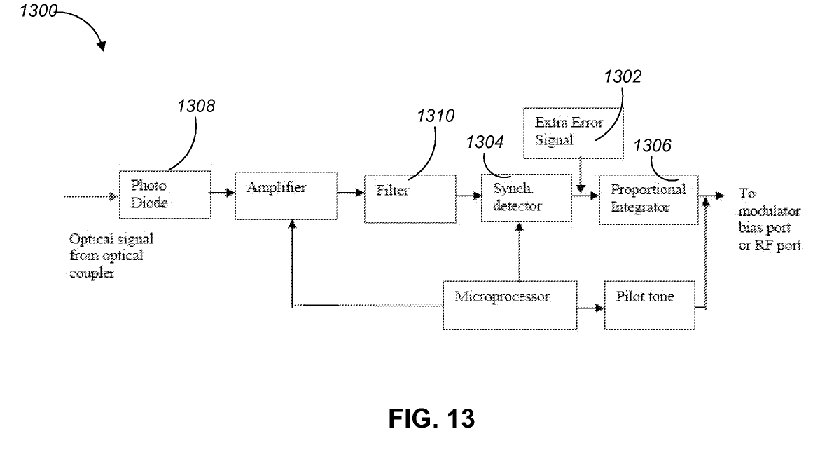

In some applications, it may be desirable to lock to points other than the Null, Peak, Quad+ and Quad− points. FIG. 13 shows a block diagram of a bias controller with tuning capability (1300). The bias controller generates a pilot tone to apply to the system. A photo detector (1308) senses the optical signal that split from the optical coupler (or splitter), which contains the pilot tone signal. A filter (1310) filters out the desired harmonics of the pilot tone signal, and a synchronous detector (1304) provides the amplitude of these harmonics, which form an error signal. An extra error signal (1302) is applied here with an amplitude that can be set by a user of the system. With a Proportional Integrator (1306), the feedback loop is closed, the error is eliminated, and the DC bias, which is needed to eliminate the error, is provided to the system.

As the skilled reader realizes, the modulator circuit (1300) still tries to eliminate the error signal (1302) (that is, the first or second harmonics of the pilot tone) depending on the desired working point, but the circuit (1300) actually locks the modulator to another point, due to extra error signal (1302) applied. No matter, how the working function drifts, the desired locking point will stay locked. The tuning range can cover the whole range of the working function.

The invention can be implemented in digital or analog electronic circuitry, or in computer hardware, firmware, software, or in combinations thereof. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

To provide for interaction with a user, the invention can be implemented on a computer system having a display device such as a monitor or LCD screen for displaying information to the user. The user can provide input to the computer system through various input devices such as a keyboard and a pointing device, such as a mouse, a trackball, a microphone, a touch-sensitive display, a transducer card reader, a magnetic or paper tape reader, a tablet, a stylus, a voice or handwriting recognizer, or any other well-known input device such as, of course, other computers. The computer system can be programmed to provide a graphical user interface through which computer programs interact with users.

Finally, the processor optionally can be coupled to a computer or telecommunications network, for example, an Internet network, or an intranet network, using a network connection, through which the processor can receive information from the network, or might output information to the network in the course of performing the above-described method steps. Such information, which is often represented as a sequence of instructions to be executed using the processor, may be received from and outputted to the network, for example, in the form of a computer data signal embodied in a carrier wave. The above-described devices and materials will be familiar to those of skill in the computer hardware and software arts.

It should be noted that the present invention employs various computer-implemented operations involving data stored in computer systems. These operations include, but are not limited to, those requiring physical manipulation of physical quantities. Usually, though not necessarily, these quantities take the form of electrical or magnetic signals capable of being stored, transferred, combined, compared, and otherwise manipulated. The operations described herein that form part of the invention are useful machine operations. The manipulations performed are often referred to in terms, such as, producing, identifying, running, determining, comparing, executing, downloading, or detecting. It is sometimes convenient, principally for reasons of common usage, to refer to these electrical or magnetic signals as bits, values, elements, variables, characters, data, or the like. It should remembered however, that all of these and similar terms are to be associated with the appropriate physical quantities and are merely convenient labels applied to these quantities.

The present invention also relates to a device, system or apparatus for performing the aforementioned operations. The system may be specially constructed for the required purposes, or it may be a general-purpose computer selectively activated or configured by a computer program stored in the computer. The processes presented above are not inherently related to any particular computer or other computing apparatus. In particular, various general-purpose computers may be used with programs written in accordance with the teachings herein, or, alternatively, it may be more convenient to construct a more specialized computer system to perform the required operations.

A number of implementations of the invention have been described. Nevertheless, it will be understood that various modifications may be made without departing from the spirit and scope of the invention. For example the filter is not limited to FP filters, and the free space of the FP filter can be different as desired by the applications. The number of time divisions can be more than 3 pieces. The techniques have been described above in the context of a DPMZ modulator, but as the skilled reader realizes, they are applicable to other individually nested modulators. The locking mode can be all Null, or all Quad, or any combination thereof, depending on the applications. Accordingly, other embodiments are within the scope of the following claims.

1. A modulator bias controller operable to control three or more nested modulators in an optical signal application, comprising:
a bias controller circuit coupled to a DC bias for each of the nested modulators, the bias controller circuit being operable to send a separate bias control signal to each of the nested modulators to set a working point for each of the nested modulators;
an optical filter located at the output of the nested modulators in the path of a tapped signal and coupled to the bias controller circuit, the optical filter being operable to pass a carrier wavelength of the optical signal and block wavelengths other than the carrier wavelength; and
at least one photo detector, coupled to the bias controller circuit, the at least one photo detector being operable to sense an error signal associated with a pilot tone.

2. The modulator bias controller of claim 1, wherein:
the modulators are Mach-Zehnder modulators forming a Dual Parallel Mach-Zehnder modulator and the optical signal transmission application is a Differential Quadrature Phase-Shift Key modulation application; and
two photo detectors are coupled to the bias controller circuit, wherein a first photo detector is operable to sense an error signal associated with the pilot tone from two of the nested modulators and a second photo detector is operable to sense an error signal associated with the pilot tone from a third nested modulator.

3. The modulator bias controller of claim 1, wherein:
the modulators are Mach-Zehnder modulators forming a Dual Parallel Mach-Zehnder modulator and the optical signal transmission application is a Single Side Band modulation application; and
a single photo detector is coupled to the bias controller circuit, the single photo detector being operable to sense an error signal associated with the pilot tone from the three nested modulators.

4. The modulator bias controller of claim 1, wherein the optical filter is selected from the group consisting of: narrow-band optical filters, interferometer based filter, comb filters, and a narrow band filter operable to work for one particular wavelength.

5. The modulator bias controller of claim 1, wherein one photo detector is a built-in photodiode in the modulators.

6. The modulator bias controller of claim 1, wherein the bias controller circuit uses a time-division method to separately control each of the nested modulators.

7. The modulator bias controller of claim 6, wherein a pilot signal is sent in sequence to the first modulator, the second modulator, and the third modulator, respectively, and the time intervals between sending of the pilot signal for locking each individual modulator are chosen so that no significant drift will occur for each modulator in the time intervals between receiving pilot signals.

8. The modulator bias controller of claim 1, wherein the bias controller circuit further is operable to apply an extra error signal to obtain a user selectable working point for each modulator.

9. A method for controlling three or more nested modulators in an optical signal application, comprising:
filtering a split output signal from the nested modulators to pass a carrier wavelength and block wavelengths other than the carrier wavelength; and
sending a separate bias control signal to each of the nested modulators, based on the filtered output signal, each separate bias control signal being operable to set a working point for each of the nested modulators.

10. The method of claim 9, wherein the modulators are Mach-Zehnder modulators forming a Dual Parallel Mach-Zehnder modulator and the optical signal transmission application is a Differential Quadrature Phase-Shift Key modulation application, further comprising:
sensing an error signal associated with a pilot tone, by using two photo detectors coupled to the bias controller circuit, wherein at least on optical directional coupler is used to split a partial optical signal into each of the photo detectors.

11. The method of claim 9, wherein the modulators are Mach-Zehnder modulators forming a Dual Parallel Mach-Zehnder modulator and the optical signal transmission application is a Single Side Band modulation application, further comprising:
sensing an error signal associated with a pilot tone, by using a photo detector coupled to the bias controller circuit

12. The method of claim 9, wherein the optical filter is selected from the group consisting of: optical Fabry-Perot filters, comb filters, and other narrow band filters.

13. The method of claim 9, wherein one photo detector is a built-in photodiode in one of the modulators.

14. The method of claim 9, wherein sending a separate bias control signal includes:
sending a time-divided bias control signal to separately control each of the nested modulators.

15. The method of claim 14, wherein sending a time-divided bias control signal includes:
sending a specific pilot signal is in sequence to the first modulator, the second modulator, and the third modulator, respectively, and
wherein the time intervals between sending the pilot signals for locking each individual modulator are chosen such that no significant drift will occur for each modulator in the time intervals between receiving pilot signals.

16. The method of claim 9, further comprising:
applying an extra error signal to the optical signal to obtain a user selectable working point for each modulator.
